(19) United States
(12) Patent Application Publication
(10) Pub. No.: US 2022/0207388 A1
(43) Pub. Date: Jun. 30, 2022

(54) AUTOMATICALLY GENERATING CONDITIONAL INSTRUCTIONS FOR RESOLVING PREDICTED SYSTEM ISSUES USING MACHINE LEARNING TECHNIQUES

(71) Applicant: Dell Products L.P., Round Rock, TX (US)

(72) Inventors: Bina K. Thakkar, Cary, NC (US); Deepak Nagarajegowda, Cary, NC (US)

(21) Appl. No.: 17/135,249

(22) Filed: Dec. 28, 2020

(51) Int. Cl. G06N 5/04; G06N 20/00

(52) U.S. Cl. CPC G06N 5/04; G06N 20/00

(57) ABSTRACT

Methods, apparatus, and processor-readable storage media for automatically generating conditional instructions for resolving predicted system issues using machine learning techniques are provided herein. An example computer-implemented method includes obtaining a dataset comprising configuration data for a system; identifying portions the configuration data associated with configuration changes unrelated to the resolution of the at least one system issue by processing the dataset using machine learning-based feature selection techniques; creating an updated dataset by filtering the identified portions from the dataset; grouping the configuration data within the updated dataset into two or more groups using hashing algorithms and similarity metrics; generating a hash model based on the groups of the configuration data; generating, using the hash models, a set of conditional instructions for resolving one or more predicted system issues; and performing at least one automated action based on the set of conditional instructions.

### FIELD

The field relates generally to information processing systems, and more particularly to issue management using such systems.

### BACKGROUND

Significant system impacts can be caused, for example, as a result of storage objects (e.g., pools, file systems, logical storage volumes (e.g., logical units or LUNs), etc.) running out of capacity. Conventional storage management techniques attempt to predict when storage objects might run out of capacity, however such techniques do not include any ability to analyze and understand steps taken by users in resolving such capacity issues. Moreover, in attempting to resolve such capacity issues, conventional storage management techniques typically include implementing ad hoc methods based on human observation, which are often error-prone and resource-intensive.

### SUMMARY

Illustrative embodiments of the disclosure provide techniques for automatically generating conditional instructions for resolving predicted system issues using machine learning techniques. An exemplary computer-implemented method includes obtaining a dataset comprising configuration data for at least one system for a given duration between onset of at least one system issue and resolution of the at least one system issue, and identifying one or more items of the configuration data associated with one or more configuration changes unrelated to the resolution of the at least one system issue by processing the dataset using one or more machine learning-based feature selection techniques. Additionally, the method includes creating an updated dataset by filtering the one or more identified items of the configuration data from the dataset, and grouping at least a portion of the configuration data within the updated dataset into two or more groups using one or more hashing algorithms in conjunction with one or more similarity metrics. The method also includes generating one or more hash models based at least in part on the two or more groups of the configuration data, wherein the one or more hash models connect at least one of the groups associated with a system issue with at least one of the groups associated with resolution of the system issue. Further, the method includes generating, using at least a portion of the one or more hash models, at least one set of conditional instructions for resolving one or more predicted system issues, and performing at least one automated action based at least in part on the at least one set of conditional instructions.

Illustrative embodiments can provide significant advantages relative to conventional storage management techniques. For example, problems associated with error-prone and resource-intensive ad hoc issue resolution efforts are overcome in one or more embodiments through automatically generating conditional instructions for resolving predicted system issues using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically generating conditional instructions for resolving predicted system issues using machine learning techniques in an illustrative embodiment.

FIG. 2 shows an example workflow using an automated predicted issue resolution instruction system in an illustrative embodiment.

FIG. 3 shows an example table representing semantic configuration changes from issue detection to resolution in an illustrative embodiment.

FIG. 4 shows an example workflow for generating recommended resolution actions using a playbook in an illustrative embodiment.

FIG. 5 is a flow diagram of a process for automatically generating conditional instructions for resolving predicted system issues using machine learning techniques in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

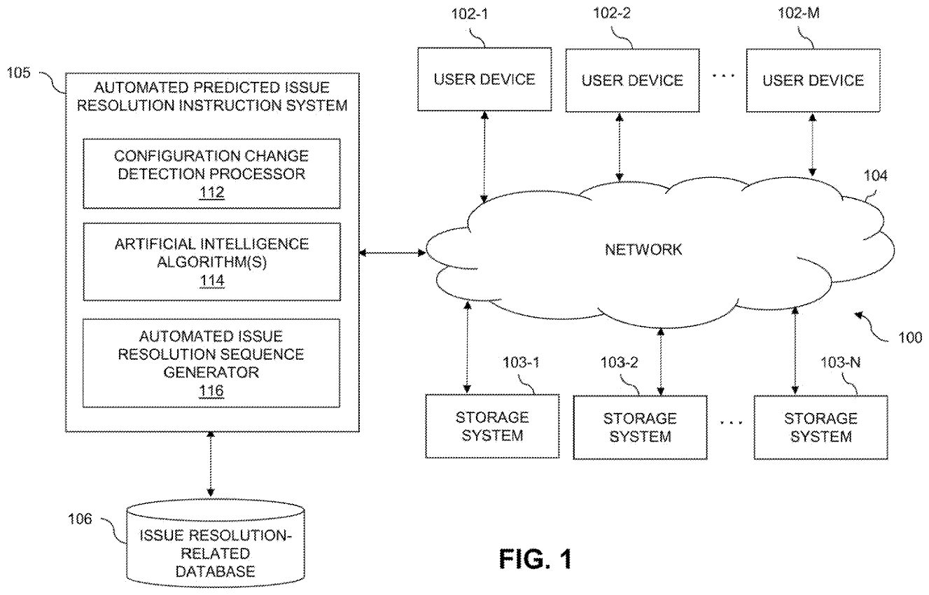

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102, and a plurality of storage systems 103-1, 103-2, . . . 103-N, collectively referred to herein as storage systems 103. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated predicted issue resolution instruction system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The storage systems 103 may comprise, for example, storage objects such as pools, file systems, LUNs, etc. The storage systems 103 in some embodiments comprise respective storage systems associated with a particular company, organization or other enterprise.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated predicted issue resolution instruction system 105 can have an associated database 106 configured to store data pertaining to issue resolution-related data, which comprise, for example, system configuration data, system issue data, system resolution action(s) data, etc.

The database 106 in the present embodiment is implemented using one or more storage systems associated with automated predicted issue resolution instruction system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated predicted issue resolution instruction system 105 can be one or more input-output devices, which illustratively comprise keyboards, displays or other types of input-output devices in any combination. Such input-output devices can be used, for example, to support one or more user interfaces to automated predicted issue resolution instruction system 105, as well as to support communication between automated predicted issue resolution instruction system 105 and other related systems and devices not explicitly shown.

Additionally, automated predicted issue resolution instruction system 105 in the FIG. 1 embodiment is assumed to be implemented using at least one processing device. Each such processing device generally comprises at least one processor and an associated memory, and implements one or more functional modules for controlling certain features of automated predicted issue resolution instruction system 105.

More particularly, automated predicted issue resolution instruction system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated predicted issue resolution instruction system 105 to communicate over the network 104 with the user devices 102, and illustratively comprises one or more conventional transceivers.

The automated predicted issue resolution instruction system 105 further comprises configuration change detection processor 112, Al algorithm(s) 114, and automated issue resolution sequence generator 116.

It is to be appreciated that this particular arrangement of modules 112, 114 and 116 illustrated in automated predicted issue resolution instruction system 105 of the FIG. 1 embodiment is presented by way of example only, and alternative arrangements can be used in other embodiments. For example, the functionality associated with modules 112, 114 and 116 in other embodiments can be combined into a single module, or separated across a larger number of modules. As another example, multiple distinct processors can be used to implement different ones of modules 112, 114 and 116 or portions thereof.

At least portions of modules 112, 114 and 116 may be implemented at least in part in the form of software that is stored in memory and executed by a processor.

It is to be understood that the particular set of elements shown in FIG. 1 for automatically generating conditional instructions for resolving predicted system issues using machine learning techniques using computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated predicted issue resolution instruction system 105 and issue resolution-related database 106 can be on and/or part of the same processing platform. Additionally or alternatively, in one or more embodiments, automated predicted issue resolution instruction system 105 and issue resolution-related database 106 can be implemented in at least one of the storage systems 103 and/or in an associated management server or set of servers.

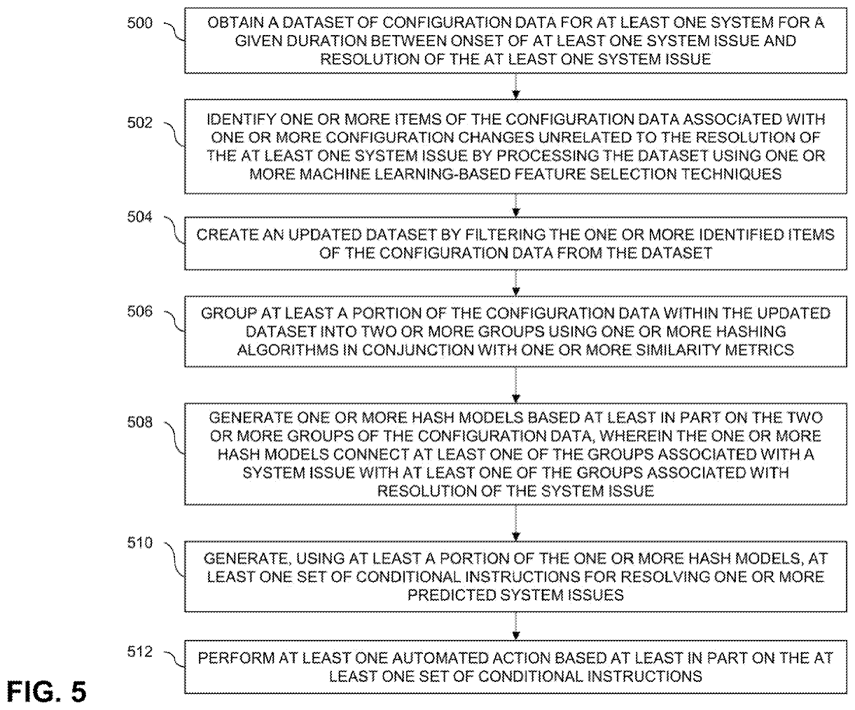

An exemplary process utilizing modules 112, 114 and 116 of an example automated predicted issue resolution instruction system 105 in computer network 100 will be described in more detail with reference to the flow diagram of FIG. 5.

Accordingly, at least one embodiment includes generating and/or implementing at least one machine learning-based algorithm to auto-generate a set of conditional instructions (also referred to herein as a playbook) for providing proactive resolution of one or more issues (e.g., storage object capacity issues) based at least in part on processing data related to past remedial actions in connection with similar issues. It is to be appreciated that while one or more exemplary embodiments are detailed herein in connection with storage object capacity issues, embodiments can also be carried out and/or implemented in connection with a variety of storage and/or processing device or system issues.

Commonly, issues related to storage objects running out of capacity would be resolved by making one or more configuration changes to the corresponding storage system(s). Such configuration changes might include, for example, deleting one or more snapshots, reclaiming used storage for one or more LUNs and/or one or more file systems, adding one or more disks, etc. Also, during the time duration between issue discovery or prediction and issue resolution, one or more configuration changes not related to the resolution could be made. Accordingly, and as detailed herein, at least one embodiment includes determining which configuration changes, from a group of multiple configuration changes, are related to and/or relevant for resolving a given issue.

By way of example, one or more embodiments include monitoring and/or tracking configuration changes of and/or within at least one storage system before and after a particular storage object (e.g., a storage pool) has transitioned from a state of FULL (i.e., out of capacity) to a state of NOT FULL (i.e., having capacity). Such an embodiment further includes determining which configuration changes took place after the storage object became FULL and which configuration changes helped the storage object transition from a state of FULL to a state of NOT FULL.

In such an embodiment, there could be a number of changes that a storage object may have experienced (e.g., reclaiming storage space, adding more capacity, disks, etc.) to bring the storage object from a state of FULL to a state of NOT FULL. Using one or more statistical significance tests (e.g., a chi-squared test), such an embodiment includes determining and/or identifying the changes that participated in and/or impacted the storage object transition from the state from FULL to the state of NOT FULL. Further, such an embodiment includes processing such identifications and/or determinations across multiple storage objects and/or storage systems to train at least one AI model to learn one or more remedial actions corresponding to one or more particular issues and/or issue types.

In connection with using one or more chi-squared statistical significance tests, at least one embodiment can include determining and/or identifying features that are statistically significant such as illustrated in the following use case example. Assume that there are 10 features (also referred to here as columns) describing two given states (in this case, FULL and NOT FULL). Assume also that there are a total of 1000 rows of data. In such a scenario, an example embodiment can include using a chi-squared test for each of the features to calculate the corresponding p-value. If a given p-value is less than, for example, 0.05, then statistical significance is indicated.

Accordingly, and as further detailed herein, one or more embodiments include automatically identifying one or more configuration changes related to resolving an issue such as, for example, a storage object running out of capacity. Based on such identification(s), such an embodiment can also include determining and/or learning resolution actions and auto-generating at least one playbook for the given issue(s). As used herein, a playbook includes a series of resolution steps for a given issue and/or problem context. Additionally, such a playbook can be used for future active remediation to prevent and/or ameliorate the given issue and/or problem.

By way merely of illustration, an example embodiment can include the following steps and/or actions. For instance, all configuration changes for a given storage object between issue creation or prediction and issue resolution are identified and captured and/or obtained as a dataset, wherein the issue relates to the given storage object running out of storage capacity. Using one or more statistical techniques, non-related configuration changes are identified and removed from the dataset. The remaining configuration changes are hashed into one or more groups (also referred to herein as buckets) based at least in part on one or more similarity parameters. Such similarity parameters can include, for example, one or more system parameters determined and/or predefined to have a statistical significance for causing one or more issues in the given system.

In such an embodiment, each bucket can represent and/or signify one or more steps or techniques involved in remediating the given issue. The configuration changes associated with and/or contained in each bucket can be combined to autogenerate at least one human-readable policy (e.g., a playbook). Additionally, such an embodiment includes processing data across one or more users' resolution efforts to facilitate teaming one or more patterns and/or insights for remediation of one or more issues. By way merely of illustration, in an example embodiment, each bucket represents a certain state of one or more given systems. For instance, assume a use case wherein a first bucket represents a system that exhibits a certain issue, and a second bucket represents a system with a resolved status for the issue. Also, in such an example, each of the buckets will pertain to the same system. Accordingly, comparing these two buckets will yield one or more system configuration changes between the two buckets, wherein such configuration changes represent one or more patterns and/or insights that may help to move a system from one state (problem/issue) to another state (resolution).

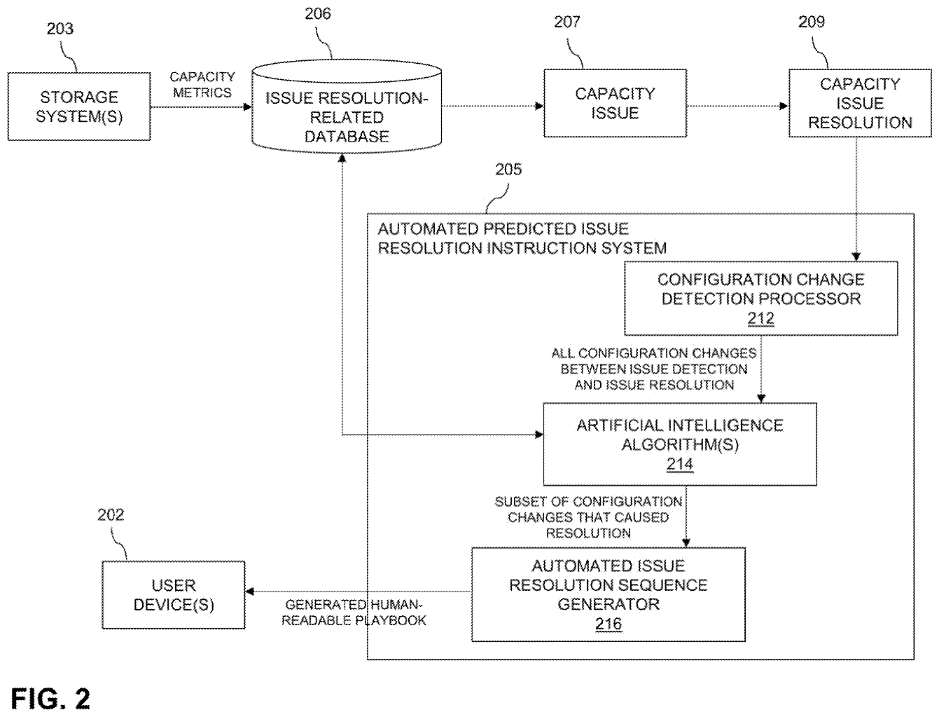

FIG. 2 shows an example workflow using an automated predicted issue resolution instruction system in an illustrative embodiment. By way of illustration, FIG. 2 depicts one or more storage systems 203 providing data including capacity metrics to issue resolution-related database 206. Based at least in part on processing one or more portions of such data, a capacity issue 207 for one or more storage objects from storage system(s) 203 is identified, and a resolution 209 is enacted and/or carried out.

Automated predicted issue resolution instruction system 205 obtains data pertaining to the capacity issue resolution 209 via configuration change detection processor 212. Subsequently, configuration change detection processor 212 provides for processing, to Al algorithm(s) 214, all configuration changes for storage system(s) 203 that occurred and/or were carried out between the time of the capacity issue detection and the time of the capacity issue resolution. As also depicted in FIG. 2, as part of such processing (and/or as part of training or re-training of the algorithm(s)), Al algorithm(s) 214 interact(s) and/or exchange(s) data with issue resolution-related database 206.

Based at least in part on the processing carried out via Al algorithm(s) 214, a subset of the above-noted configuration changes are identified as causing and/or being involved with the capacity issue resolution, and that subset is provided to automated issue resolution sequence generator 216, which uses at least a portion of such inputs to generate a human-readable playbook. The automated issue resolution sequence generator 216 outputs the generated playbook to one or more user devices 202 for use, for example, in one or more support operations, one or more maintenance operations, one or more planning operations, etc.

At least one embodiment includes data extraction, data preprocessing and statistical significance determination(s). Such an embodiment includes obtaining (from at least one given storage system) configuration data and performing data preprocessing steps on at least a portion of the obtained data, wherein such preprocessing steps can include normalization techniques and feature engineering. Based at least in part on the preprocessing output(s), such an embodiment can further include identifying and/or extracting one or more features from the processed data, performing one or more statistical significance tests (e.g., chi-squared tests) on the one or more features, and determining and/or identifying the feature(s) (e.g., the statistically significant feature(s)) that drive and/or affect at least one given capacity issues in the given storage system(s).

Based on the statistically significant features, one or more embodiments include monitoring and/or identifying configuration changes pertaining to the feature and issue status(es). In other words, such an embodiment includes collecting feature values from the start of and/or detection of a given issue until the given issue is resolved.

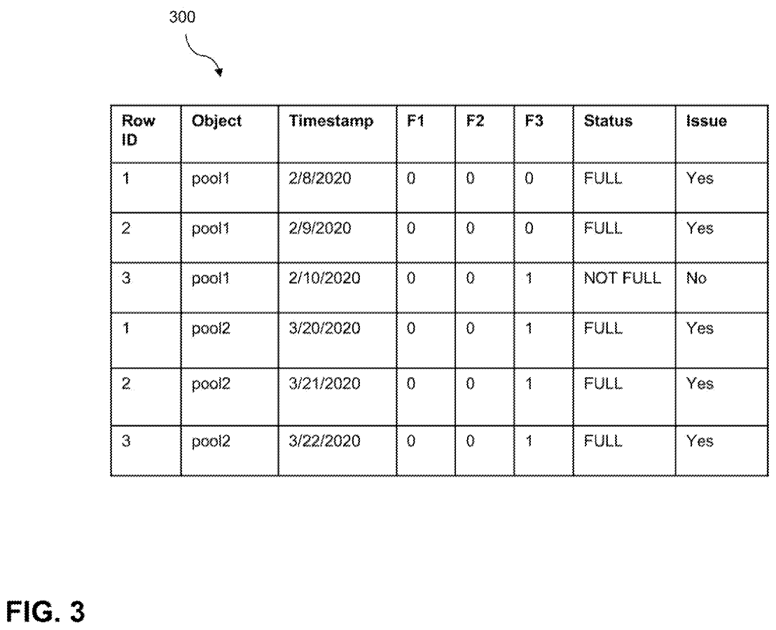

Accordingly, at least one embodiment includes change tracking of storage object configuration(s). By way of illustration, FIG. 3 shows an example table 300 representing semantic configuration changes from issue detection to resolution in an illustrative embodiment. In connection with example table 300, assume a list of statistically significant features (F1, F2, F3), wherein F1 represents “total size,” F2 represents “size used.” and F3 represents “number of snapshots.” In such an example dataset, features F1, F2 and F3 are re-engineered to a binary format (i.e., 0 and 1), wherein 0 indicates no change and 1 indicates a change from the previous time period.

As also detailed herein, one or more embodiments include applying at least one hashing algorithm. An example embodiment can include applying a hashing algorithm to each row of the data (e.g., only on features values) in a table such as, for instance, table 300 in FIG. 3.

With respect to hashing, it is to be appreciated that similar records, when hashed, will produce the same output and hence can be assigned a specific label. In one or more embodiments, such records are assigned into the same bucket or group. For example, records within Bucket A are all similar to each other, while records in Bucket B are not similar to records in Bucket A, but the records in Bucket A are more similar to the records in Bucket in B than the records in Bucket C. Typically, such operations can be scaled to large numbers of records, as hashing techniques are efficient. Records pertaining to particular issues will fall into a specific list of buckets, and records pertaining to resolved issues will fall into a different list of buckets. Additionally, one or more embodiments can include examining and/or processing data from resolved issue buckets and reverse the hashing process to determine which of one or more configuration changes within at least one system led to resolution of the issue(s). Such a determination can be validated, for example, using one or more statistical significance tests.

At least one embodiment also includes building one or more hash models which connect at least one issue/problem bucket with at least one resolution bucket using a hash identifier. By way merely of illustration, consider an example hash model wherein Bucket A contains configuration state data of storage objects typically associated with particular issues, and Bucket B contains configuration state data of storage objects typically associated with resolved issues. Despite this example, it is to be appreciated that one or more embodiments can encompass and/or implement varying numbers of buckets representing a varying number of issues/problems and varying numbers of buckets representing a varying number of resolutions for one or more storage system models (or storage object(s) thereof). Additionally or alternatively, for each storage system model, one or more embodiments include generating a hash model (as resolution options may vary across products and models).

With respect to hashing, at least one embodiment includes converting each record and/or document to a small signature using a hashing function H. Suppose, for example, a record in a given corpus is denoted by d. Accordingly, in such an example, H(d) is the signature and it is small enough to fit in memory. Further, by way of illustration, the following determinations can be made in connection with this signature:

If similarity(d1,d2) is high, then Probability(H(d1)==H(d2)) is high; and

If similarity(d1,d2) is low, then Probability(H(d1)==H(d2)) is low.

In one or more embodiments, choice of hashing function is linked to the similarity metric being used. For example, at least one embodiment includes using a Jaccard similarity (JS) algorithm and at least one MinHashing algorithm.

By way of illustration, consider the following Jaccard similarity example:

A={0,1,2,5,6};

B={0,2,3,4,5,7,9}; and

Jaccard(A,B)=|A∩B|/|A∪B|=|{0,2,5}|/|{0,1,2,3,4,5,6,7,9}|=3/9=0.33.

Further, consider a MinHashing example with the following sets:

S1={1,2,5};

S2={3};

S3={2, 3, 4, 6}; and

S4={1,4,6}.

Accordingly, in such a Jaccard similarity algorithm and MinHashing example, JS(S1, S3)=|{2}|/|{2,3,4,5,6}|=1/6.

More specifically, in connection with such an example, at least one embodiment can include representing the four sets as a single matrix, and subsequently carrying out MinHashing steps as follows. A first step includes randomly permuting the items by permuting the rows of the matrix, and a second step includes recording the first element corresponding to the first value of “1” in each column of the matrix. Further, a third step includes estimating the Jaccard similarity based at least in part on such recordings.

As also detailed herein, one or more embodiments include using one or more hash models to create at least one playbook. In such an embodiment, a hash model for a given product type and model shows at least one path to resolution from an issue state, and multiple such processes can be combined and/or collected for multiple storage arrays and/or models to create a comprehensive playbook. For example, as noted herein, a portion of such a playbook for storage system model xyz can include the following: Step #1: If Problem Bucket #1, then Resolution Bucket #1; Step #2: Reverse hash (the contents of the noted resolution bucket) to make human-readable.

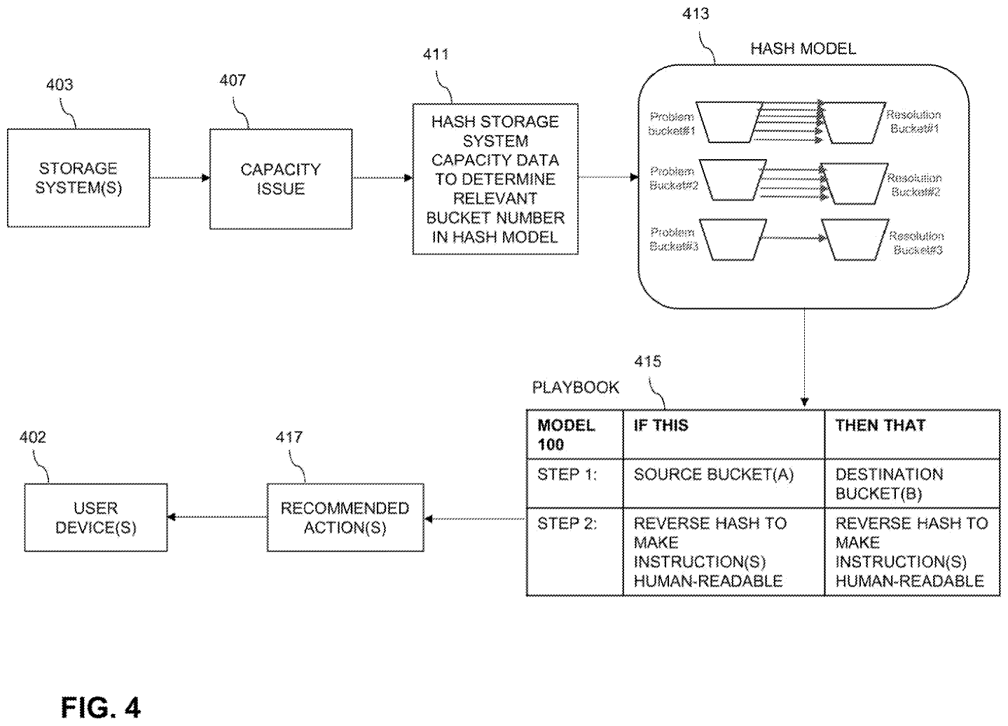

Additionally or alternatively, one or more embodiments include using a playbook to resolve at least one active issue. Accordingly, FIG. 4 shows an example workflow for generating recommended resolution actions using a playbook in an illustrative embodiment. By way of illustration, FIG. 4 depicts one or more storage systems 403, and a capacity issue 407 identified and/or derived therefrom. Based at least in part on processing data pertaining to the capacity issue 407 and the storage system(s) 403, hash storage system capacity data 411 is generated and used to determine at least one relevant bucket number (i.e., relevant to capacity issue 407) in hash model 413.

Based on the determined relevant bucket number(s) from hash model 413, playbook 415 is generated. As depicted in the FIG. 4 example, playbook 415 is specific to the model of storage system(s) 403 (e.g., Model 100), and playbook 415 includes a set of human-readable conditional steps. For example, playbook 415 includes a first step that indicates that if the issues relate to source bucket(A), then resolution instructions can be found in destination bucket(B). Additionally, playbook 415 includes a second step that indicates that if the information in source bucket(A) is reverse hashed to render the data human-readable, then the instructions in destination bucket(B) are to be reverse hashed and rendered human-readable.

As also depicted in FIG. 4, based at least in part on the contents of playbook 415, a set of one or more recommended actions 417 are output to user device(s) 402 for use in one or more actions (e.g., one or more automated resolution actions).

FIG. 5 is a flow diagram of a process for automatically generating conditional instructions for resolving predicted system issues using machine learning techniques in an illustrative embodiment. It is to be understood that this particular process is only an example, and additional or alternative processes can be carried out in other embodiments.

In this embodiment, the process includes steps 500 through 512. These steps are assumed to be performed by automated predicted issue resolution instruction system 105 utilizing its modules 112, 114 and 116.

Step 500 includes obtaining a dataset comprising configuration data for at least one system for a given duration between onset of at least one system issue and resolution of the at least one system issue. One or more embodiments can also include preprocessing the obtained dataset using one or more normalization techniques and one or more feature engineering techniques. Also, in an example embodiment, the at least one system can include at least one storage system, and the at least one system issue can include at least one storage capacity issue attributed to one or more storage objects within the at least one storage system.

Step 502 includes identifying one or more items of the configuration data associated with one or more configuration changes unrelated to the resolution of the at least one system issue by processing the dataset using one or more machine learning-based feature selection techniques. In at least one embodiment, the one or more machine learning-based feature selection techniques include one or more chi-squared tests.

Step 504 includes creating an updated dataset by filtering the one or more identified items of the configuration data from the dataset. In one or more embodiments, creating the updated dataset includes processing configuration changes in the configuration data remaining in the updated dataset.

Step 506 includes grouping at least a portion of the configuration data within the updated dataset into two or more groups using one or more hashing algorithms in conjunction with one or more similarity metrics. In at least one embodiment, grouping the at least a portion of the configuration data includes using at least one MinHash technique in conjunction with a Jaccard similarity metric.

Step 508 includes generating one or more hash models based at least in part on the two or more groups of the configuration data, wherein the one or more hash models connect at least one of the groups associated with a system issue with at least one of the groups associated with resolution of the system issue. In one or more embodiments, generating one or more hash models includes connecting the at least one of the groups associated with a system issue with the at least one of the groups associated with resolution of the system issue using at least one hash identifier.

Step 510 includes generating, using at least a portion of the one or more hash models, at least one set of conditional instructions for resolving one or more predicted system issues. In one or more embodiments, generating the at least one set of conditional instructions includes rendering the at least one set of conditional instructions human-readable.

Step 512 includes performing at least one automated action based at least in part on the at least one set of conditional instructions. In at least one embodiment, performing at least one automated action includes automatically resolving a predicted system issue using the at least one set of conditional instructions. Such an embodiment can also include fine-tuning the one or more machine learning-based feature selection techniques based at least in part on data pertaining to the automatic resolution of the predicted system issue using the at least one set of conditional instructions.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate conditional instructions for resolving predicted system issues using machine learning techniques. These and other embodiments can effectively overcome problems associated with error-prone and resource-intensive ad hoc issue resolution efforts.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors.

Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are nm on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

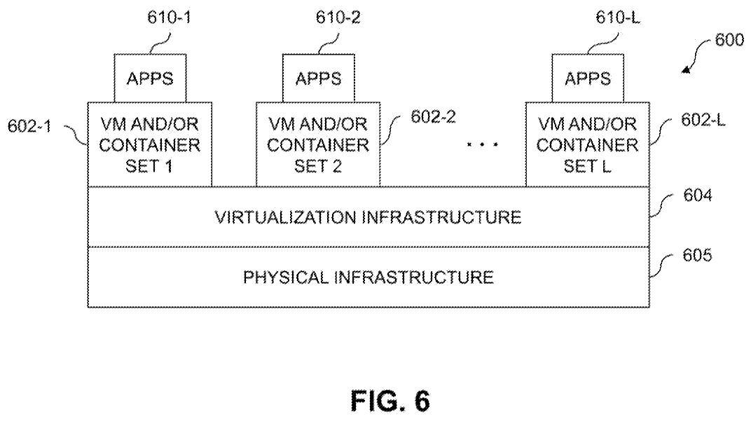

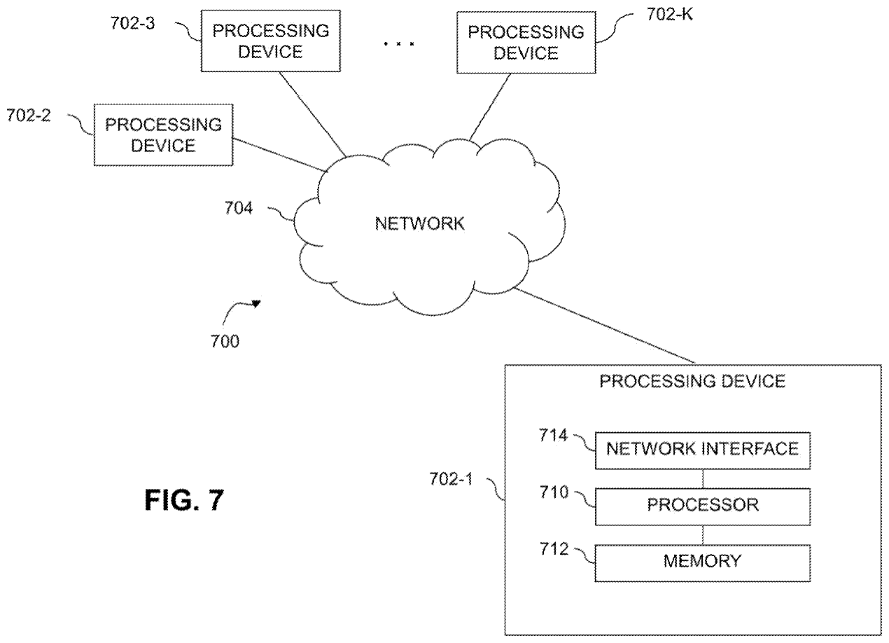

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an application-specific integrated circuit (ASIC), a field-programmable gate array (FPGA) or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining a dataset comprising configuration data for at least one system for a given duration between onset of at least one system issue and resolution of the at least one system issue;
identifying one or more items of the configuration data associated with one or more configuration changes unrelated to the resolution of the at least one system issue by processing the dataset using one or more machine learning-based feature selection techniques;
creating an updated dataset by filtering the one or more identified items of the configuration data from the dataset;
grouping at least a portion of the configuration data within the updated dataset into two or more groups using one or more hashing algorithms in conjunction with one or more similarity metrics;
generating one or more hash models based at least in part on the two or more groups of the configuration data, wherein the one or more hash models connect at least one of the groups associated with a system issue with at least one of the groups associated with resolution of the system issue;
generating, using at least a portion of the one or more hash models, at least one set of conditional instructions for resolving one or more predicted system issues; and
performing at least one automated action based at least in part on the at least one set of conditional instructions;
wherein the method is performed by at least one processing device comprising a processor coupled to a memory.

2. The computer-implemented method of claim 1, wherein the one or more machine learning-based feature selection techniques comprise one or more chi-squared tests.

3. The computer-implemented method of claim 1, wherein creating the updated dataset comprises processing configuration changes in the configuration data remaining in the updated dataset.

4. The computer-implemented method of claim 1, wherein grouping the at least a portion of the configuration data comprising using at least one MinHash technique in conjunction with a Jaccard similarity metric.

5. The computer-implemented method of claim 1, wherein generating one or more hash models comprises connecting the at least one of the groups associated with a system issue with the at least one of the groups associated with resolution of the system issue using at least one hash identifier.

6. The computer-implemented method of claim 1, wherein performing at least one automated action comprises automatically resolving a predicted system issue using the at least one set of conditional instructions.

7. The computer-implemented method of claim 6, further comprising:
fine-tuning the one or more machine learning-based feature selection techniques based at least in part on data pertaining to the automatic resolution of the predicted system issue using the at least one set of conditional instructions.

8. The computer-implemented method of claim 1, wherein generating the at least one set of conditional instructions comprises rendering the at least one set of conditional instructions human-readable.

9. The computer-implemented method of claim 1, further comprising:
preprocessing the obtained dataset using one or more normalization techniques and one or more feature engineering techniques.

10. The computer-implemented method of claim 1, wherein the at least one system comprises at least one storage system, and wherein the at least one system issue comprises at least one storage capacity issue attributed to one or more storage objects within the at least one storage system.

11. A non-transitory processor-readable storage medium having stored therein program code of one or more software programs, wherein the program code when executed by at least one processing device causes the at least one processing device:
to obtain a dataset comprising configuration data for at least one system for a given duration between onset of at least one system issue and resolution of the at least one system issue;
to identify one or more items of the configuration data associated with one or more configuration changes unrelated to the resolution of the at least one system issue by processing the dataset using one or more machine learning-based feature selection techniques;
to create an updated dataset by filtering the one or more identified items of the configuration data from the dataset;
to group at least a portion of the configuration data within the updated dataset into two or more groups using one or more hashing algorithms in conjunction with one or more similarity metrics;
to generate one or more hash models based at least in part on the two or more groups of the configuration data, wherein the one or more hash models connect at least one of the groups associated with a system issue with at least one of the groups associated with resolution of the system issue;
to generate, using at least a portion of the one or more hash models, at least one set of conditional instructions for resolving one or more predicted system issues; and
to perform at least one automated action based at least in part on the at least one set of conditional instructions.

12. The non-transitory processor-readable storage medium of claim 11, wherein the one or more machine learning-based feature selection techniques comprise one or more chi-squared tests.

13. The non-transitory processor-readable storage medium of claim 11, wherein creating the updated dataset comprises processing configuration changes in the configuration data remaining in the updated dataset.

14. The non-transitory processor-readable storage medium of claim 11, wherein grouping the at least a portion of the configuration data comprising using at least one MinHash technique in conjunction with a Jaccard similarity metric.

15. The non-transitory processor-readable storage medium of claim 11, wherein generating one or more hash models comprises connecting the at least one of the groups associated with a system issue with the at least one of the groups associated with resolution of the system issue using at least one hash identifier.

16. An apparatus comprising:
at least one processing device comprising a processor coupled to a memory;
the at least one processing device being configured:
to obtain a dataset comprising configuration data for at least one system for a given duration between onset of at least one system issue and resolution of the at least one system issue;
to identify one or more items of the configuration data associated with one or more configuration changes unrelated to the resolution of the at least one system issue by processing the dataset using one or more machine learning-based feature selection techniques;
to create an updated dataset by filtering the one or more identified items of the configuration data from the dataset;
to group at least a portion of the configuration data within the updated dataset into two or more groups using one or more hashing algorithms in conjunction with one or more similarity metrics;
to generate one or more hash models based at least in part on the two or more groups of the configuration data, wherein the one or more hash models connect at least one of the groups associated with a system issue with at least one of the groups associated with resolution of the system issue;
to generate, using at least a portion of the one or more hash models, at least one set of conditional instructions for resolving one or more predicted system issues; and
to perform at least one automated action based at least in part on the at least one set of conditional instructions.

17. The apparatus of claim 16, wherein the one or more machine learning-based feature selection techniques comprise one or more chi-squared tests.

18. The apparatus of claim 16, wherein creating the updated dataset comprises processing configuration changes in the configuration data remaining in the updated dataset.

19. The apparatus of claim 16, wherein grouping the at least a portion of the configuration data comprising using at least one MinHash technique in conjunction with a Jaccard similarity metric.

20. The apparatus of claim 16, wherein generating one or more hash models comprises connecting the at least one of the groups associated with a system issue with the at least one of the groups associated with resolution of the system issue using at least one hash identifier.
